(19) United States
(12) Patent Application Publication
(10) Pub. No.: US 2002/0140570 A1
(43) Pub. Date: Oct. 3, 2002

(54) RKE key fob dual function response algorithm

(76) Inventor: Joseph Ploucha, Sterling Heights, MI (US)

Correspondence Address: LAURA M. SLENZAK, SIEMENS CORPORATION, 186 WOOD AVENUE SOUTH, ISELIN, NJ, 08830, US

(21) Appl. No.: 09/900,776

(22) Filed: Jul. 6, 2001

Related U.S. Application Data
(60) Provisional application No. 60/280,023, filed on Mar. 30, 2001.

(51) Int. Cl. G05B 19/00

(52) U.S. Cl. 340/825.69; 340/5.72

(57) ABSTRACT

A remote control system for a vehicle has at least two vehicle systems to be controlled. An actuator permits a control unit to communicate selectively with each system. Once a particular system is selected, then communication is routed to the selected system. A transmitter is used to permit remote control of the selected system.

This application claims priority to U.S. Provisional Patent Application Serial No. 60/280,023 filed on Mar. 30, 2001.

### BACKGROUND OF THE INVENTION

Remote keyless entry systems currently exist that provide an operator of a vehicle the opportunity to lock and unlock the doors of a vehicle. Typically, these systems comprise a key fob with a transmitter that stores a key code, which is transmitted to the vehicle's security system upon actuation of a button on the key fob. If the key code matches a security code stored by the vehicle, a control unit within the vehicle permits the actuation of the vehicle's locks. While such systems provide remote operation of the vehicle's security system, they do not provide control over the vehicle's other systems, such as the stereo system of the vehicle.

Remote access of the vehicle's stereo system is desirable to consumers. Such systems do exist in a less convenient and more expensive form. One such system permits remote control of the vehicle's stereo system from the rear of the passenger cab by using a separate remote control to operate the various functions of the system. This system requires a separate transmitter, receiver and control unit to operate the various features on the remote control. Furthermore, a vehicle operator must also now keep track of this remote control or lose remote access to the stereo system.

A need exists for a more convenient and inexpensive means of controlling remotely the various features of a vehicle's systems.

### SUMMARY OF THE INVENTION

The present invention involves the use of existing remote keyless entry systems to provide remote access not only to the vehicle's security system but also to allow remote control of another vehicle system. The invention permits a single transmitter, receiver and control unit to control multiple systems by having the operator select in advance the system to receive commands and thus to be remotely controlled. In practicing the invention, the operator first selects from a number of vehicle systems to control. Once the vehicle system is selected, the key fob is used to transmit a signal to the vehicle. The signal is received by the vehicle and then routed to the selected vehicle system.

For example, a key fob used to control the vehicle's security system may also be used to control the vehicle's entertainment system, such as a stereo system. By selecting in advance the system to be controlled, the signal from the key fob may be communicated to the appropriate vehicle system. If control over the vehicle's security system is desired, then the operator selects the security system and the signal from the key fob is used to control the security system. On the other hand, if control over the stereo system is sought, a switch for the audio system is selected and further communication for the key fob is interpreted by the system as a signal to control the stereo system. Thus, a single transmitter and receiver may be used to control multiple vehicle systems, including the vehicle's security system and the vehicle's stereo system.

The selection of the vehicle system may be through a manually actuated switch. This switch may be found in the vehicle or alternatively on the key fob. In the vehicle, the ignition switch could itself be used to select between vehicle systems, such as between a vehicle security system and a vehicle's stereo system. If the ignition switch is turned to a position that allows key removal, then the invention would direct communication from the key fob to the vehicle's security system. On the other hand, if the vehicle ignition is turned to an accessory position, then the key fob would remotely control the stereo system.

The vehicle system may also be selected by using a general user interface that would permit the operator to access graphically the various systems that the operator desires to control at any particular moment. A display may be used to provide a more convenient interface for the operator.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows.

FIG. 1 shows a schematic view of an embodiment of the invention including control unit, security system, entertainment system, electronic key device, and actuator.

FIG. 2 shows the electronic key device of FIG. 1 including an actuator.

### DETAILED DESCRIPTION OF THE PREFERRED EMBODIMENTS

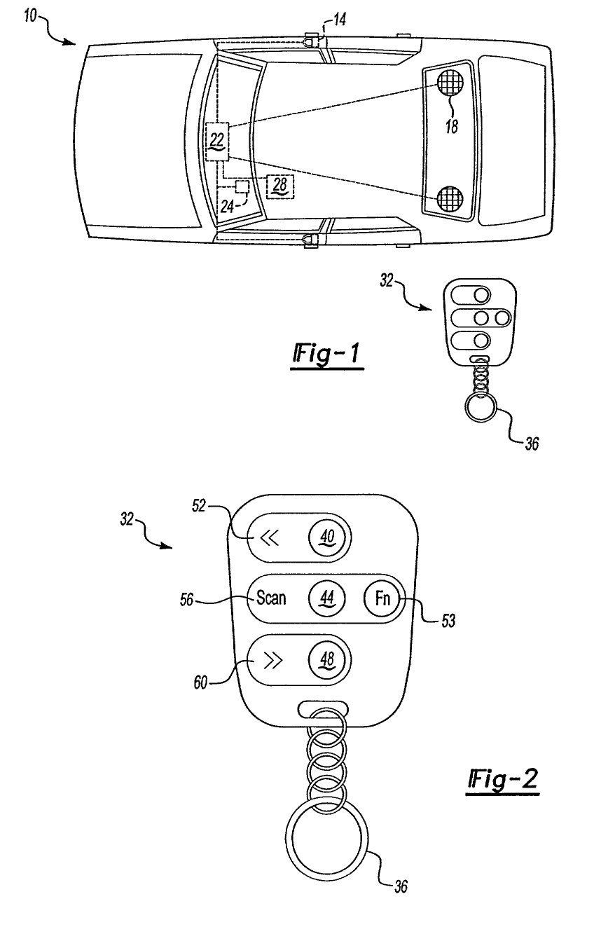

The invention is schematically shown in FIG. 1 in the form of a system in vehicle 10, such as an automobile. As known, a plurality of vehicle systems such as security system 14 and entertainment system 18 exists on vehicle 10. Control unit 22 is in selective communication with each of these systems. Actuator such as vehicle ignition 24 or general user interface 28 permits the operator to select the particular vehicle system to be controlled.

Electronic key device 32 has a transmitter that allows remote communication with control unit 22, which has a receiver programmed to identify a particular electronic key device 32. Electronic key device 32 is preferably a key fob with key chain 36. Key chain 36 permits selective attachment to a vehicle key.

One embodiment of the invention uses vehicle ignition 24 to allow the operator to select the system to be controlled. If control unit 22 detects the presence of a key in ignition switch 24, then control unit 22 presumes that the operator wishes to remotely control entertainment system 18, such as a stereo system. On the other hand, in the event that no key is detected, then control unit presumes that the operator wishes to control the vehicle's security system 14. In this way, a single transmitter in electronic key device 32 may remotely control each of the vehicle's systems independently of each other. Very little additional componentry is required as well.

For example, at a campfire, an operator may leave his key in ignition switch 24 and take electronic key device 32 with him. Control unit 22 presumes remote operation of entertainment system 18. Accordingly, communications from electronic key device 32 are interpreted as communications to control entertainment system 18.

Another embodiment of the invention may rely on general user interface 28 such as a display as actuator. The display would offer a selection of vehicle systems to control, which the operator could select by touch screen or other means known in the art. Operator simply makes the choice on screen, thereby routing communications to the selected system for the immediate future.

FIG. 2 shows electronic key device 32 with key chain 36. Electronic key device has lock button 40, trunk release button 44, and unlock button 48 as known. In addition, electronic key device 32 has actuator, here shown as function button 53, that permits the operator to toggle between control of the vehicle's security system and the vehicle's entertainment system. Next to lock button 40 is indicator 52 that shows how to increase volume of entertainment system 18 while indicator 60 shows how to decrease volume. Indicator 56 shows a feature that permits the operator to scan the stations available to entertainment system 18. Each of these additional features may be actuated by depressing function button 53, which then communicates the operator's intention to use these additional features to control unit 22. Control unit 22 then reads further signals from an electronic key device 32 as signals to be communicated to the vehicle's entertainment system 18 for remote control.

The system parameters controlled as well as the types of controls disclosed herein are intended as examples. One can envision other parameters and types of control that may be remotely operated as taught by this disclosure. Moreover, other vehicle systems may be controlled employing the same invention. These systems include, but are not limited to, power window systems, heating and air conditioning systems, and other electronic systems. One of ordinary skill in the art could implement the invention for such systems based on this disclosure.

The aforementioned description is exemplary rather than limiting. Many modifications and variations of the present invention are possible in light of the above teachings. The preferred embodiments of this invention have been disclosed. However, one of ordinary skill in the art would recognize that certain modifications would come within the scope of this invention. Hence, within the scope of the appended claims, the invention maybe practiced otherwise than as specifically described. For this reason, the following claims should be studied to determine the true scope and content of this invention.

What is claimed is:

1. A method of remote control for a vehicle comprising the steps of:
selecting among a plurality of vehicle systems to control with one of said systems being a security system;
transmitting a signal to a vehicle;
receiving the signal;
communicating the signal to the selected vehicle system; and
controlling the selected vehicle systems based on the received signal.

2. The method of claim 1 wherein the signal is transmitted by an electronic key device.

3. The method of claim 1 wherein another of said plurality of vehicle systems is an entertainment system.

4. The method of claim 3 wherein the entertainment system is an audio system.

5. The method of claim 1 wherein the selection occurs through a switch.

6. The method of claim 5 wherein the switch is an ignition switch.

7. The method of claim 5 wherein the switch is a function button on an electronic key device.

8. The method of claim 1 wherein the selection occurs through a general user interface.

9. The method of claim 8 wherein the general user interface comprises a display.

10. A remote control system for a vehicle comprising:
at least two vehicle systems with one of said systems being a security system and one an audio system;
a control unit selectively in communication with each of said vehicle systems;
an actuator in communication with said control unit, permitting the selection of communication among each of said vehicle systems; and
a transmitter in communication with said control unit wherein said transmitter comprises an electronic key device.

11. A remote control system for a vehicle comprising;
at least two vehicle systems with one of said systems being a security system;
a control unit selectively in communication with each of said vehicle systems;
an actuator in communication with said control unit, permitting the selection of communication among each of said vehicle systems; and
a transmitter in communication with said control unit.

12. The remote control system of claim 11 wherein another of said vehicle systems is an entertainment system.

13. The remote control system of claim 12 wherein said entertainment system is an audio system.

14. The remote control system of claim 11 wherein said transmitter comprises an electronic key device.

15. The remote control system of claim 11 wherein said actuator comprises an ignition switch.

16. The remote control system of claim 11 wherein said actuator comprises a general user interface.

17. The remote control system of claim 16 wherein said general user interface comprises a display.

18. The remote control system of claim 11 wherein said actuator comprises a function button.
